(19) United States
(12) Patent Application Publication
(10) Pub. No.: US 2012/0002224 A1
(43) Pub. Date: Jan. 5, 2012

(54) IMAGE FORMING APPARATUS TO ADD SPECIFIC DATA TO IMAGE, AND IMAGE FORMING METHOD OF ADDING THE SPECIFIC DATA TO THE IMAGE

(75) Inventor: Taizo KIMOTO, Tokyo (JP)

(73) Assignees: Toshiba Tec Kabushiki Kaisha, Tokyo (JP); Kabushiki Kaisha Toshiba, Tokyo (JP)

(21) Appl. No.: 13/175,048

(22) Filed: Jul. 1, 2011

Related U.S. Application Data
(60) Provisional application No. 61/361,368, filed on Jul. 2, 2010.

(51) Int. Cl. H04N 1/60

(52) U.S. Cl. 358/1.9

(57) ABSTRACT

According to one embodiment, an image forming apparatus includes a data adding part and an image forming part. The data adding part acquires first identification data from a first storage part provided in a colorant container to contain a colorant and storing the first identification data intrinsic to the colorant container, and adds first additional data based on the first identification data to image data to be formed on a sheet. The image forming part forms an image on the sheet based on the image data to which the first additional data is added.

### CROSS-REFERENCE TO RELATED APPLICATION

This application is based upon and claims the benefit of priority from U.S. provisional application 61/361,368, filed on Jul. 2, 2010; the entire contents of which are incorporated herein by reference.

### FIELD

Embodiments described herein relate generally to a technique to add specific data to an image.

### BACKGROUND

When an image forming apparatus prints an image, such as a bill or a negotiable instrument, which should not be printed, in order to identify the image forming apparatus from the printed matter, hitherto, the image forming apparatus stores identifying data intrinsic to the apparatus, embeds the identifying data in the image in an invisible state, and prints the image. In the related art image forming apparatus, when there is an abnormality in the storage part of the identifying data, when access can not be made to the storage part, or when there is an abnormality in the identifying data itself, a screen for calling a serviceman is displayed, and the apparatus is made impossible to be used.

However, the situation in which the image forming apparatus is actually identified from the copy of the bill or the negotiable instrument is limited to the case where an investigation is made for an unfair practice of a specific person, and seldom occurs. To make impossible to use the apparatus when the storage part of the identifying data is abnormal for the situation which seldom occurs can be said to be a method with a great loss.

### DESCRIPTION OF THE DRAWINGS

FIG. 1 is a block diagram showing a structure of an image forming apparatus.

FIG. 2 is a flowchart for explaining image forming method by the image forming apparatus.

FIG. 3 is a flowchart for explaining a print propriety determination method by the image forming apparatus.

### DETAILED DESCRIPTION

According to one embodiment, an image forming apparatus includes a data adding part and an image forming part. The data adding part acquires first identification data from a first storage part provided in a colorant container to contain a colorant and storing the first identification data intrinsic to the colorant container, and adds first additional data based on the first identification data to image data to be formed on a sheet. The image forming part forms an image on the sheet based on the image data to which the first additional data is added.

Hereinafter, embodiments will be described with reference to the drawings.

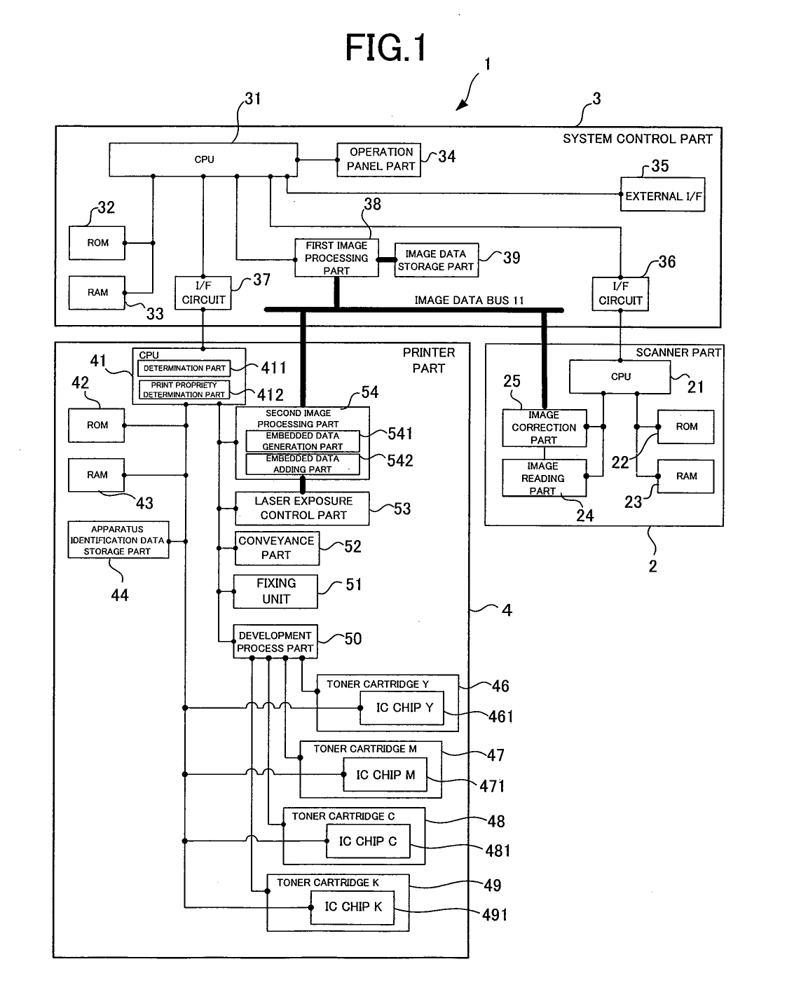

FIG. 1 is a block diagram showing a structure of an image forming apparatus 1.

The image forming apparatus 1 is an MFP (Multi Function Peripheral). The image forming apparatus 1 includes a scanner part 2, a system control part 3 and a printer part 4.

The scanner part 2 includes a CPU 21 (Central Processing Unit), a ROM 22 (Read Only Memory), a RAM 23 (Random Access Memory), an image reading part 24 and an image correction part 25. The CPU 21 controls the whole scanner part 2 by reading and executing programs from the ROM 22. The image reading part 24 reads an image on a document by a CCD (Charge Coupled Device Image Sensor), and outputs image data. The image correction part 25 performs shading correction or 3-line correction on the image data outputted by the image reading part 24.

The system control part 3 includes a CPU 31, a ROM 32, a RAM 33, an operation panel part 34, an external I/F 35, I/F circuits 36 and 37, a first image processing part 38 and an image data storage part 39. The CPU 31 controls the whole apparatus 1 by reading and executing programs from the ROM 32. Besides, the CPU 31 controls the CPU 21 of the scanner part 2 and a CPU 41 of the printer part 4 through the I/F circuits 36 and 37. The operation panel part 34 is a touch panel and serves both as a display part to display a setting screen and the like and an operation input part to accept a user's operation input.

The first image processing part 38 performs ACS (Auto Color Selection) processing, color conversion processing, high-quality picture processing, gamma correction processing and gradation processing on the image data outputted from the image correction part 25 of the scanner part 2 through an image data bus 11. The image data storage part 39 is a dedicated storage part used by the first image processing part 38.

The printer part 4 (image forming part) forms an image on a sheet. The printer part 4 includes the CPU 41, a ROM 42, a RAM 43, an apparatus identification data storage part 44 (second storage part), toner cartridges YMCK 46 to 49 (colorant containers), IC chips YMCK 461 to 491 (first storage part), a development process part 50, a fixing unit 51, a conveyance part 52, a laser exposure control part 53 and a second image processing part 54. The CPU 41 controls the whole printer part 4. The CPU 41 includes, as function parts, a determination part 411 and a print propriety determination part 412.

The ROM 42 stores a maker, a model name and a type of the image forming apparatus 1 in addition to various programs to be read in the CPU 41.

The apparatus identification data storage part 44 stores a serial number (manufacture number) as second identification data intrinsic to the image forming apparatus 1.

The toner cartridges YMCK 46 to 49 contain toners (colorants) of Y (Yellow), M (Magenta), C (Cyan) and K (Black). The toner cartridge K 49 (black colorant container) contains the K toner (black colorant). The toner cartridges YMC 46˜48 (color colorant containers) contain toners (color colorants) of YMC colors different from black.

The IC chips YMCK 461 to 491 are provided integrally with the toner cartridges YMCK 46 to 49, respectively, and store serial numbers as first identification data intrinsic to the toner cartridges YMCK 46 to 49.

The development process part 50 transfers a toner image to a sheet. The development process part 50 includes photoconductive drums provided for the respective colors and to carry toner images of the respective colors, a laser optical system to expose the respective photoconductive drums and to form electrostatic latent images on the photoconductive drums, developing units provided for the respective colors and to develop the electrostatic latent images on the photoconductive drums by supplying toners from the toner cartridges YMCK 46 to 49 to the photoconductive drums, and a transfer belt on which the toner images of the respective colors from the photoconductive drums are superimposed and one color toner image is transferred and which transfers the toner image to the sheet.

The fixing unit 51 heats and presses the sheet and fixes the toner image on the sheet to the sheet.

The conveyance part 52 conveys the sheet to the respective parts.

The laser exposure control part 53 controls the laser optical system based on the image data processed by the second image processing part 54 and forms the electrostatic latent image on the photoconductive drums.

The second image processing part 54 includes, as an function part or ASIC, an embedded data generation part 541 (additional data generation part) and an embedded data adding part 542 (data adding part).

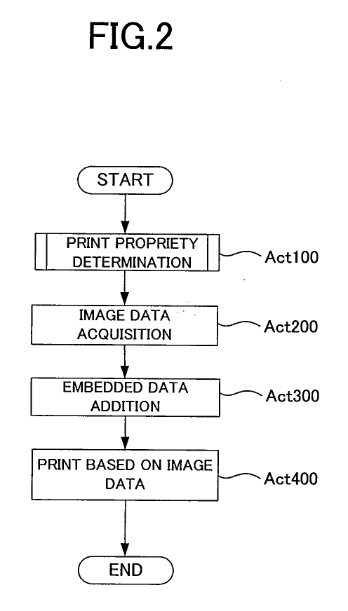

Hereinafter, an image forming method by the image forming apparatus 1 will be described with reference to a flowchart of FIG. 2.

When a power source is turned on, the image forming apparatus 1 makes a print propriety determination, that is, determines whether an image in which tracking data is embedded can be printed (Act 100).

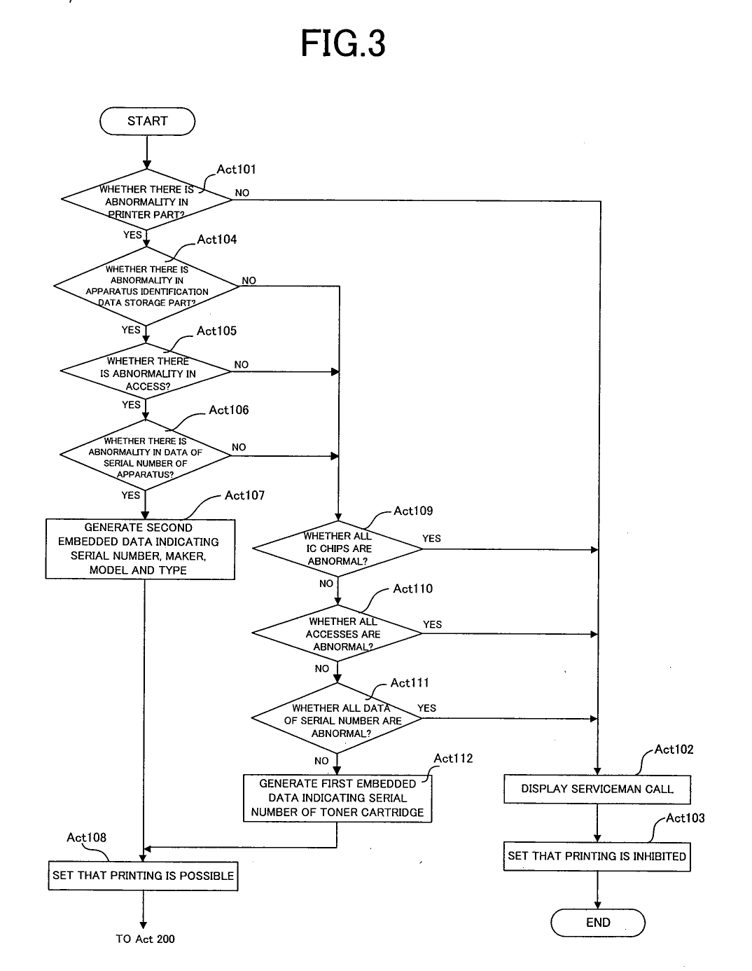

FIG. 3 is a flowchart for explaining the print propriety determination by the image forming apparatus 1.

In the print propriety determination, first, the determination part 411 (CPU 41) of the printer part 4 determines whether there is an abnormality in the printer part 4 (Act 101). When there is an abnormality in the development process part 50, the fixing unit 51 or the conveyance part 52 of the printer part 4 (Act 101: NO), the CPU 31 displays an instruction to call a serviceman on the operation panel part 34 (Act 102). The print propriety determination part 412 sets that printing is inhibited (Act 103). Incidentally, as an example of the abnormality, a case where the development process part 50 or the fixing unit 51 does not normally operate can be mentioned.

On the other hand, when there is no abnormality in the printer part 4 (Act 101: YES), the determination part 411 determines whether there is an abnormality in adding the second embedded data of the apparatus 1 to the image data (Act 104 to 106). The second embedded data of the apparatus 1 includes a serial number (second identification data) intrinsic to the image forming apparatus 1, and a maker, a model name and a type of the image forming apparatus 1. The image formed based on the second embedded data is an invisible specific pattern indicating the serial number, the maker, the model name and the type of the image forming apparatus 1.

The determination as to whether there is an abnormality in adding the second embedded data (additional data) to the image data is specifically performed as follows. First, the determination part 411 determines whether there is an abnormality in the apparatus identification data storage part 44 itself to store the serial number of the image forming apparatus 1 (Act 104). Next, the determination part 411 determines whether there is an abnormality in the access to the apparatus identification data storage part 44 (Act 105). Subsequently, the determination part 411 determines whether there is an abnormality in the data itself of the serial number acquired from the apparatus identification data storage part 44 (Act 106).

When the determination part 411 determines that there is no abnormality in adding the second embedded data to the image data, that is, when the determination part 411 determines that there is no abnormality in all of the apparatus identification data storage part 44 itself, the access to the apparatus identification data storage part 44 and the data of the serial number (Act 104 to Act 106: YES), the embedded data generation part 541 acquires the serial number from the apparatus identification data storage part 44. Besides, the embedded data generation part 541 acquires the maker, the machine name and the type of the image forming apparatus 1 from the ROM 42, generates the second embedded data based on the serial number, the maker, the machine name and the type (Act 107). The second embedded data is such that the image formed based on the second embedded data becomes a specific pattern indicating the serial number, the maker, the machine name and the type of the image forming apparatus 1. The specific pattern is an invisible pattern. The second embedded data is for the image data of Y color which is hardest for a human being to visually recognize. Accordingly, the specific pattern is added to only the image of Y color, and the specific pattern is not added to the images of MCK colors. The respective specific patterns are arranged at respective positions of all the image so that the image forming apparatus 1 can be specified even from a part of the sheet.

Subsequently, the print propriety determination part 412 (CPU 41) of the printer part 4 sets that printing is possible (Act 108).

On the other hand, when the determination part 411 determines that there is an abnormality in adding the second embedded data to the image data, that is, when there is an abnormality in one of the apparatus identification data storage part 44 itself, the access to the apparatus identification data storage part 44 and the serial number data (Act 104 to Act 106: NO), the determination part 411 determines whether the first embedded data of the toner cartridges YMCK 46 to 49 can be added to the image data (Act 109 to 111). The first embedded data indicates the serial number (first identification data) intrinsic to the toner cartridges YMCK 46 to 49. Besides, the image formed based on the first embedded data is an invisible specific pattern indicating the serial number of the toner cartridges YMCK 46 to 49.

The determination as to whether the first embedded data relating to the toner cartridges YMCK 46 to 49 can be added to the image data is specifically performed such that the determination part 411 determines all of the IC chips YMCK 461 to 491 themselves to store the serial number of the toner cartridges YMCK 46 to 49 are abnormal (Act 109). Besides, the determination part 411 determines whether all of the accesses to the IC chips YMCK 461 to 491 are abnormal (Act 110). Further, the determination part 411 determines whether all of the data of the serial number acquired from the IC chips YMCK 461 to 491 are abnormal (Act 111).

When the determination part 411 determines that the first embedded data can not be added to the image data, that is, determines that all of the IC chips YMCK 461 to 491 are abnormal, when determined that all accesses to the IC chips YMCK 461 to 491 are abnormal, or all data of the serial number are abnormal (Act 109 to Act 111: YES), the CPU 31 displays an instruction for calling a serviceman on the operation panel part 34 (Act 102).

When the determination part 411 determines that the first embedded data can be added to the image data, that is, when determined that the IC chips YMCK 461 to 491 of a certain color, the access to the IC chips YMCK 461 to 491 of the certain color, and the serial number of the IC chips YMCK 461 to 491 of the certain color are normal (Act 109 to Act 111: NO), the embedded data generation part 541 acquires the serial number of the toner cartridges YMCK 46 to 49 from the normal IC chips YMCK 461 to 491. Specifically, when the IC chip K 491 of the toner cartridge K49 of K color is normal, the embedded data generation part 541 acquires the serial number of the toner cartridge K 49 from the IC chip K 491. When the IC chip K491 is not normal, the embedded data generation part acquires the serial number from one of the IC chips YMC 461 to 481. Then, the embedded data generation part 541 generates the first embedded data based on the acquired serial number (Act 112). The first embedded data is such that the image formed based on the first embedded data becomes a specific pattern indicating the serial number of the IC chips YMCK 461 to 491 of the toner cartridges YMCK 46 to 49. The specific pattern is an invisible pattern. The first embedded data is for the image data of Y color which is hardest for a human being to visually recognize. Accordingly, the specific pattern is added to only the image of Y color, and the specific pattern is not added to the images of MCK colors. The respective specific patterns are arranged at respective positions of the whole image so that the image forming apparatus 1 can be specified even from a part of the sheet.

Subsequently, the print propriety determination part 412 sets that printing is possible (Act 108).

Thereafter, as shown in the flowchart of FIG. 2, when the setting is that printing is possible, the first image processing part 38 acquires image data and processes the image data (Act 200).

Subsequently, the embedded data adding part 542 acquires the second embedded data indicating the serial number of the apparatus 1 or the first embedded data indicating the serial number of the toner cartridges YMCK 46 to 49 from the ROM 42, and adds the data to the image data (Act 300).

The CPU 41 and the laser exposure control part 53 control the printer part 4 based on the image data to which the embedded data is added, and prints the image in which the specific pattern indicating the serial number of the apparatus 1 or the serial number of the toner cartridges YMCK 46 to 49 is invisibly embedded to the sheet (Act 400).

In this embodiment, when the normal serial number of the image forming apparatus 1 can not be acquired, the image forming apparatus 1 is not stopped, and instead of the serial number of the image forming apparatus 1, the serial number of the toner cartridges YMCK 46 to 49 is invisibly embedded as the concealed pattern (specific pattern) in the image. Thus, in this embodiment, the apparatus 1 can be continuously used without stopping the apparatus, and the convenience of the image forming apparatus 1 can be improved. Since the toner cartridges YMCK 46 to 49 are consumables which are replaced many times, when the serial number of the toner cartridges YMCK 46 to 49 is embedded as the invisible specific pattern in the image, the newest information (area, type of user, etc.) can be acquired from the specific pattern. Accordingly, to embed, as the specific pattern, the serial number of the toner cartridges YMCK 46 to 49 in the image is useful for tracking the image forming apparatus 1 and is effective in investigating an unfair practice.

### Modified Example

An image formed based on the embedded data may a character, not a specific pattern. The specific pattern may not be added to an image of Y color, but may be added to an image of another color MCK. Besides, in the embodiment, although the serial number of the toner cartridges YMCK 46 to 49 is embedded as the specific pattern in the image, the specific pattern indicating the serial number of the toner cartridges YMCK 46 to 49 may be visibly added (superimposed) to the image. That is, the first additional data based on the serial number may be added (superimposed) to the image data.

The respective function parts such as the determination part 411 may be realized appropriately by the CPUs 21, 31 and 41 and the ASIC.

As described above in detail, the technique disclosed herein can provide the technique to add specific data to an image.

While certain embodiments have been described, these embodiments have been presented by way of example only, and are not intended to limit the scope of invention. Indeed, the novel apparatus, methods and system described herein may be embodied in a variety of other forms; furthermore, various omissions, substitutions and changes in the form of the apparatus, methods and system described herein may be made without departing from the spirit of the inventions. The accompanying claims and their equivalents are intended to cover such forms or modifications as would fall within the scope and spirit of the inventions.

What is claimed is:

1. An image forming apparatus comprising:
data adding part that acquires first identification data from a first storage part provided in a colorant container to contain a colorant and storing the first identification data intrinsic to the colorant container, and adds first additional data based on the first identification data to image data to be formed on a sheet; and
an image forming part to form an image on the sheet based on the image data to which the first additional data is added.

2. The apparatus of claim 1, further comprising:
a second storage part to store second identification data intrinsic to the image forming apparatus; and
a determination part to determine whether there is an abnormality in adding second additional data based on the second identification data to the image data, wherein
if the determination part determines that there is no abnormality, the data adding part adds the second additional data to the image data, and if the determination part determines that there is an abnormality, the data adding part adds the first additional data to the image data.

3. The apparatus of claim 1, wherein the data adding part acquires the first identification data from the first storage part provided in one of a plurality of the colorant containers, and adds the first additional data based on the first identification data to the image data.

4. The apparatus of claim 3, wherein
the colorant containers include a black colorant container to contain a black colorant and a color colorant container to contain a color colorant having a color different from black, and
the data adding part acquires the first identification data from the first storage part provided in the black colorant container, and adds the first additional data based on the first identification data to the image data.

5. The apparatus of claim 2, wherein if the determination part determines that there is an abnormality in at least one of the second storage part, access to the second storage part, and the second identification data stored in the second storage part, the determination part determines that there is an abnormality in adding the second additional data based on the second identification data to the image data.

6. The apparatus of claim 5, wherein
a plurality of the colorant containers are provided,
if the determination part determines that there is an abnormality in at least one of the second storage part, the access to the second storage part, and the second identification data stored in the second storage part, and determines that there is no abnormality in a first storage part of one of the colorant containers, access to the first storage part, and first identification data stored in the first storage part, first additional data based on the first identification data of the colorant container having no abnormality is added to the image data.

7. The apparatus of claim 1, wherein the first additional data is the data in which an image formed on the sheet based on the first additional data can not be visually recognized.

8. The apparatus of claim 2, wherein the second additional data is the data in which an image formed on the sheet based on the second additional data can not be visually recognized.

9. The apparatus of claim 2, further comprising an identification information acquisition part to acquire user identification data for identifying a user, wherein
if the determination part determines that there is an abnormality, the data adding part adds the invisible first additional data based on the first identification data and the user identification data to the image data to be formed on the sheet.

10. An image forming method based on image data added with additional data by an image forming apparatus including an image forming part to form an image on a sheet by using a colorant contained in a colorant container, comprising:
acquiring first identification data from a first storage part provided in the colorant container and storing the first identification data intrinsic to the colorant container;
adding first additional data based on the first identification data to the image data to be formed on the sheet; and
forming the image on the sheet based on the image data to which the first additional data is added.

11. The method of claim 10, wherein
the image forming apparatus includes a second storage part to store second identification data intrinsic to the image forming apparatus;
a determination is made as to whether there is an abnormality in adding second additional data based on the second identification data to the image data,
if the determination is that there is no abnormality, the second additional data is added to the image data, and if the determination is that there is an abnormality, the first additional data is added to the image data.

12. The method of claim 10, wherein a plurality of the colorant containers are provided, the first identification data is acquired from the first storage part provided in one of the plurality of colorant containers, and the first additional data based on the first identification data is added to the image data.

13. The method of claim 12, wherein
the colorant containers include a black colorant container to contain a black colorant and a color colorant container to contain a color colorant having a color different from black, and
the first identification data is acquired from the first storage part provided in the black colorant container, and the first additional data based on the first identification data is added to the image data.

14. The method of claim 11, wherein when a determination is made that there is an abnormality in at least one of the second storage part, access to the second storage part, and the second identification data stored in the second storage part, a determination is made that there is an abnormality in adding the second additional data based on the second identification data to the image data.

15. The method of claim 14, wherein
a plurality of the colorant containers are provided,
if a determination is made that there is an abnormality in at least one of the second storage part, the access to the second storage part, and the second identification data stored in the second storage part, and a determination is made that there is no abnormality in a first storage part of one of the colorant containers, access to the first storage part and first identification data stored in the first storage part, first additional data based on the first identification data of the colorant container having no abnormality is added to the image data.

16. The method of claim 11, wherein the first additional data is the data in which an image formed on the sheet based on the first additional data can not be visually recognized.

17. A computer readable recording medium non-temporarily storing an image forming program to cause an image forming apparatus, which includes an image forming part to form an image on a sheet by using a colorant contained in a colorant container, to form the image based on image data to which additional data is added, wherein the recording medium stores the image forming program to cause the image forming apparatus to execute:
acquiring first identification data from a first storage part provided in the colorant container and storing the first identification data intrinsic to the colorant container;
adding first additional data based on the first identification data to the image data to be formed on the sheet; and
forming the image on the sheet based on the image data to which the first additional data is added.

18. The recording medium of claim 17, wherein
the image forming apparatus includes a second storage part to store second identification data intrinsic to the image forming apparatus;
a determination is made as to whether there is an abnormality in adding second additional data based on the second identification data to the image data,
if the determination is that there is no abnormality, the second additional data is added to the image data, and if the determination is that there is an abnormality, the first additional data is added to the image data.

19. The recording medium of claim 17, wherein a plurality of the colorant containers are provided, the first identification data is acquired from the first storage part provided in one of the plurality of colorant containers, and the first additional data based on the first identification data is added to the image data.

20. The recording medium of claim 19, wherein
the colorant containers include a black colorant container to contain a black colorant and a color colorant container to contain a color colorant having a color different from black, and
the first identification data is acquired from the first storage part provided in the black colorant container, and the first additional data based on the first identification data is added to the image data.
